(19) United States
(12) Patent Application Publication
(10) Pub. No.: US 2007/0104370 A1
(43) Pub. Date: May 10, 2007

(54) System and method for smart polling

(75) Inventor: Walter Rosenbaum, Paris (FR)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, Munich (DE)

(21) Appl. No.: 10/579,841

(22) PCT Filed: Nov. 18, 2004
(86) PCT No.: PCT/EP04/13112

§ 371 Date: May 17, 2006

Related U.S. Application Data
(60) Provisional application No. 60/520,658, filed on Nov. 18, 2003.

(51) Int. Cl. G06K 9/18; G06K 7/10

(52) U.S. Cl. 382/182; 382/321

(57) ABSTRACT

A method of decoding images applies in parallel at least a first and a second optical character recognition process to an image. The image includes many categorizations. Further, the method determines if the first and second optical character recognition processes produce a substantially similar image result. If the image result is not similar a highest weighted OCR process categorization based result is selected. The highest weighted OCR process categorization based result is assigned to the image result on a categorization by categorization basis.

### CROSS REFERENCE TO RELATED APPLICATIONS

The present application claims priority to U.S. provisional application Ser. No. 60/520,658, which is herein incorporated by reference.

### BACKGROUND OF THE INVENTION

Image recognition is generally performed by optical character recognition (OCR) processing. An application for such image recognition is in the postal or mail handling arts wherein a destination address is read off of an address face of a mail item. Other applications may be envisioned by the skilled artisan. In order to ensure accurate reading or decoding of the image by OCR processing, multiple independent OCR processes may run concurrently or non-concurrently over a same image. Their respective results may be considered and/or compared in an effort to determine the most reliable processing results or decode of the scanned address.

OCR processing in mail handing applications is a combination of four substantially independent processes: address block location, binarization, OCR processing and database lookup. In brief, address block location is the location of information on an address face of an envelope. Binarization is the transformation of gray-level images into binary. OCR processing is the mapping and identification of an image as an alpha or numeric character. Database look up is the rationalization of a stream of successive characters output by the OCR by matching the process results with an elaborate set of relational databases comprising postal code, city, street and addressee information that are used to identify a destination. The aforementioned processes, when taken together, are used to scan an address face image and map it, with reasonable certainty, into a sortation decision. For purposes of this application, the aforementioned will be referred to simply as OCR process.

Given the OCR process complexity and the inconsistency of destination addresses, results of respective OCR processes vary in regards to accuracy. As such, a system and method of comparing and weighting the results of respective OCR processes is necessary in order to achieve overall results that are within an operable or working level or margin of error. Such levels or margins may vary upon application. However, assignment of weight and/or comparison level is a matter of statistics which may be applied by known computer means across a variety of applications. By voting or polling we can pool multiple independent OCR results and thereby the error rate inherent with OCR processes would be reduced.

The general field of improving OCR processes has been addressed in the prior art. FIG. 1 discloses an arrangement wherein several OCR processes 1-3 are arranged in series 14. An image 10 is introduced into the first 1, then second 2, and then third 3 OCR process if the former processes fail to read and decode the image 10. If the image is effectively read and decoded by one of the three OCR processes, a result 12 is yielded. While effective in decoding images, this arrangement also maintains an error rate which may be too high for many applications. One reason for a high error rate lay in the all or nothing approach to image reading and decoding. Here, the image is either decoded by one of the three OCR processes or an error occurs. There is no in-between.

FIG. 2 depicts the three OCR processes (1-3) of FIG. 1 arranged in parallel 20, each further being connected to a voter 22. The voter attempts to find a consensus and selects among the OCR processes results of the image reading and decoding based on a majority rule. At least 2 of the 3 OCR processes must agree in order to decode the destination address for the polling to be effective. A problem with this method is the costs involved with operating at least three OCR processes, as well as gaining and working with often mutually incompatible OCR process internal proprietary processes that make reliability ranking difficult.

FIG. 3 depicts the parallel voter arrangement of FIG. 2 with two OCR processes. This represents a more economical arrangement than the requirement for 3 OCR processes per FIG. 2 or would represent the circumstance where one of the 3 OCR processes was totally unable to resolve the subject address The operation is essentially the same as in FIG. 2, however only two as oppose to three OCR processes are used. However, a decision based on a majority vote is not possible with only two OCR processes.

In the prior art, several approaches for discrimination of final most reliable decode are given such as selecting which result represents the maximal depth of address decode or using datum internal (usually unique between OCR processes and manufacturer proprietary) to the respective OCR processes to assign related confidence level and select accordingly between contending alternative address decodes.

Problems remain with the prior art processes, namely, that they remain susceptible to fault based on depth of decode caused by directory errors or poor thresholding. Additionally, the processes rely upon an all or nothing determination of OCR process performance. Yet another prior art solution entails accessing OCR internal processes so as to create a confidence level based upon internal performance levels of the OCR processes being employed. This solution carries with it the burdens, as above, of additional processing and access to often proprietary information associated with the OCR internal processing. Additionally, reliability measures used by various vendors of OCR processes are often incompatible. Accordingly, a need exists for a practical polling of OCR processes which maximizes the information available to arrive at a best possible and most accurate possible result.

### SUMMARY OF THE INVENTION

An advantage of the present invention is to enhance performance of two or more OCR processes in regards to reading and decoding an image. This and other objects are achieved by reducing the all or nothing approach of prior art solutions to a weighted tabulation of various performance successes of a particular reading and decoding by a particular OCR process. Such weight may be known in advance based upon assessment of past OCR process performances under similar circumstances and/or such performance data gathered over time. Such past performance is made available through appropriately stored data records which are accessed and otherwise retrieved upon appropriate OCR process application. Such data records may further be continually updated by using video coding operators to truth randomly selected polling decisions and thereby continually confirm and refine a given OCR process' relative performance based once again on categories that are nominally self-evident during the scanning and OCR process. Because such information is electronically stored, it is available to a large number of applications without geographical or language restrictions—the latter being overcome by standards application.

The data records relate to an OCR process performance as applied to set events or categorizations that are nominally assessable during automatic processing. Such categorizations include: letter vs. flat vs. parcel, window envelope with transparency, numeric field vs. alpha characters field, character pitch and font, noticeable skew, handprint vs. machine print, color background, interference background (bleed through), matrix print, outward address, inward address, addressee, endorsement reading, and stamp value reading. Other considerations may also be used.

The data records, based upon the aforementioned criteria, are statistically quantified so as to provide an OCR process based performance weights. As an example, we can select the OCR process to accept for the decode based on the statistically measured factors such as whether we are reading a flat versus a letter or combine in statistical fashion the respective factors of merit for a flat mail having numerics and a window envelope.

Once determined, the results of that OCR process with respect to the aforementioned criteria will be given and the polling choice considered over the results of the other OCR processes. Accordingly, the strong points, i.e. the most successful aspects, of each of a plurality of OCR process are polled to arrive at a composite resulting reading and decoding.

### BRIEF DESCRIPTION OF THE SEVERAL VIEWS OF THE DRAWINGS

The above and other advantages of the present invention will become clear from the specification below and the claims appended thereto when taken in conjunction with the drawings wherein:

FIGS. 1 to 3 depict prior art processes;

FIG. 4 depicts a performance monitoring of a plurality of OCR processes;

FIG. 5 depicts numerics performance;

FIG. 6 depicts letters performance;

FIG. 7 depicts flats performance;

FIG. 8 depicts an operation phase wherein a decision is weighted;

FIG. 9 depicts numerics weighting;

FIG. 10 depicts letters weighting; and

FIG. 11 depicts a flowchart of the present method.

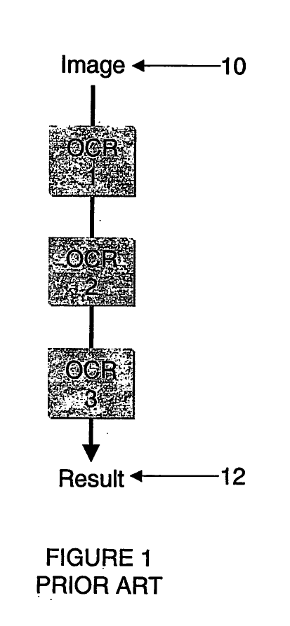

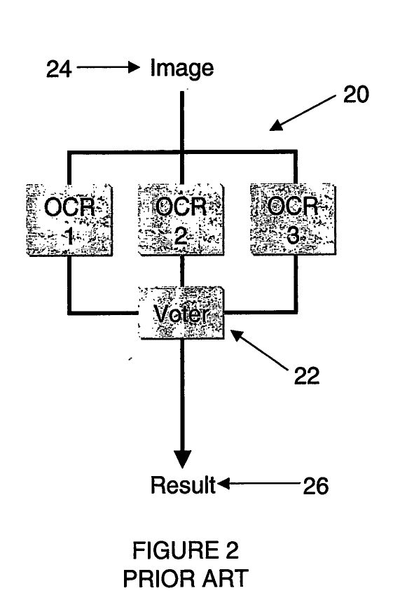

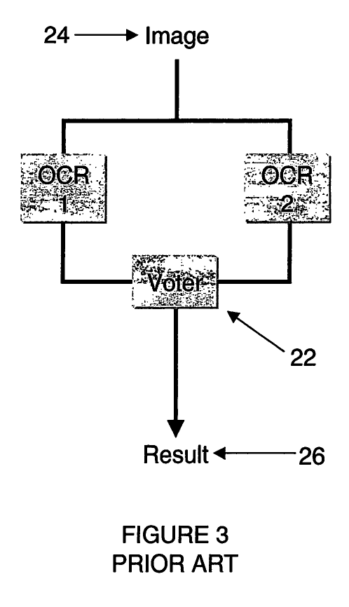

### DETAILED DESCRIPTION OF THE INVENTION

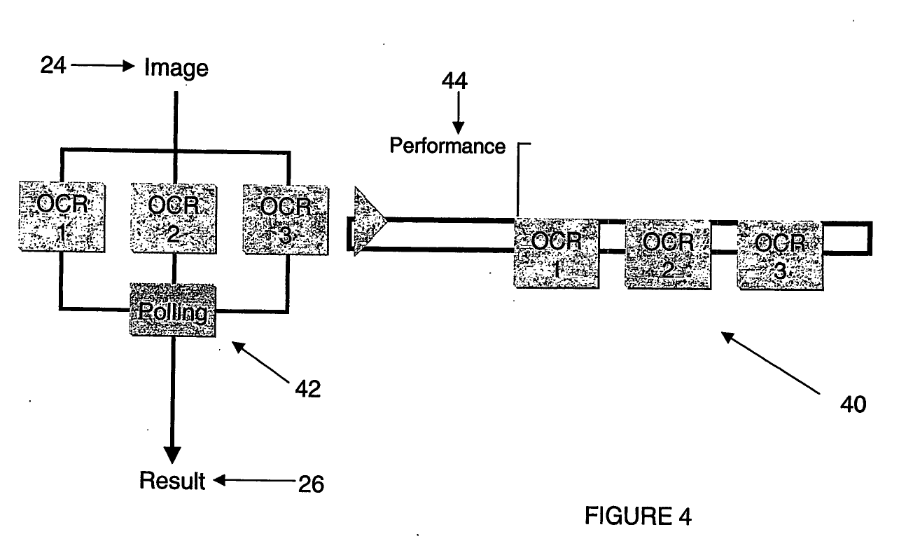

The present invention will now be discussed with respect to the above listed figures, starting with FIG. 4, wherein like numerals refer to like elements. FIG. 4 depicts performance monitoring 40 wherein the OCR processes are polled 42 based upon individual results according to preset categorizations general to both OCR processes, the data of which is provided during manual encoding. The statistical categorizations include the following domains: letter vs. flat vs. parcel, window envelope with transparency, numeric field vs. alpha characters field, character pitch and font, measurable skew, handprint vs. machine print, color background, interference background (bleed through), matrix print, outward address, inward address, addressee, endorsement, and stamp value. Other considerations my be included as envisioned by one skilled in the art.

Such a statistical categorization can be done by prior testing and be updated and refined by having encoders truth randomly selected polling events where the OCR processes differed. Encoders may receive every, almost every, or other number of unsuccessfully decoded images. Additionally, the number and type of categorization may vary upon application. Considering a world wide application and a typically numerical answer to such categorizations, the language of the categorization is inconsequential and the geographical location of the encoders also equally fluid. Rather an indication of OCR process' performance with respect to at least one of the above criteria is sought. For purposes herein it will be assumed that (FIG. 4): an image 42 was fed to the three OCR processes 1-3. Although the invention has particular value when a decision needs to be made with only 2 (or an even number) OCR processes are in contention, the cited examples show 3 OCR processes in contention to stress the ease of assimilating multiple OCR processes by virtue of not requiring any internal specification or proprietary internal information.

FIG. 4 depicts performance based OCR processing 44. Hence, the OCR processes are polled and a decoding selected based upon prior computed statistical weighting per a categorization such as discussed above. In operation and as will be seen in the subsequent figures, once at least a workable amount of data is amassed concerning the individual OCR process performance per criteria or categorization, each OCR process may be so weighted for the decision process. Additional, resolution and refinement can be accrued by having operators truthed via random polling decisions and as dictated by the results update/refine the statistics supporting the categorization.

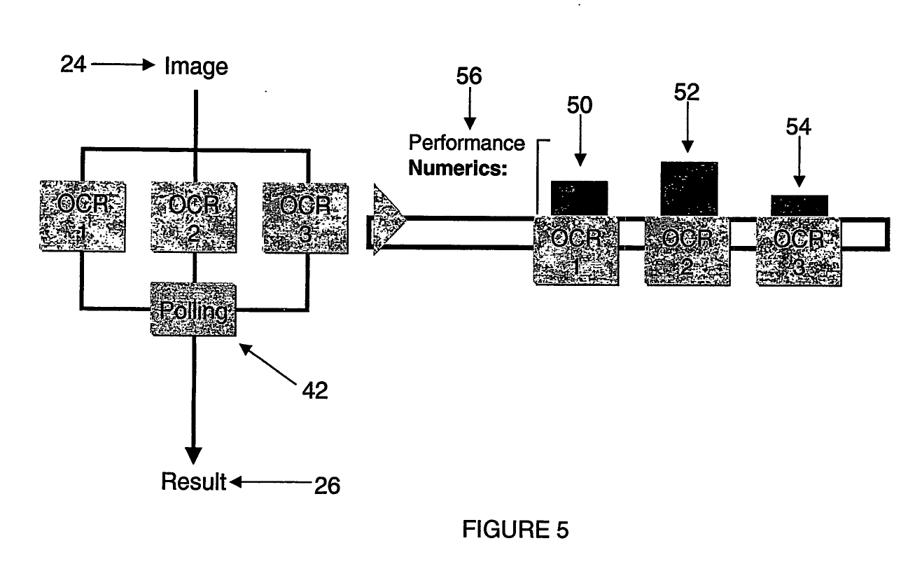

By way of example, in FIG. 5, each OCR process 1-3 includes bar graphs 50, 52, 54, whose height represents the respective OCR process performance in successfully reading and decoding numerics 56. As depicted, OCR process 2 ranks highest (52), then OCR process 1 (50), then OCR process 3 (54). In operation, the polling element 42 would consult the database for the relevant data records (depicted as bar graphs), electronically determine a largest value (herein 52) and provide a weighted value to OCR 2. Should the value be within acceptable application tolerances (rejecting a null hypothesis with the next closest OCR process), the OCR 2 reading and coding of numerics will be assumed correct. This data retrieval and evaluation is performed automatically by appropriate electronic means such as a properly programmed computer.

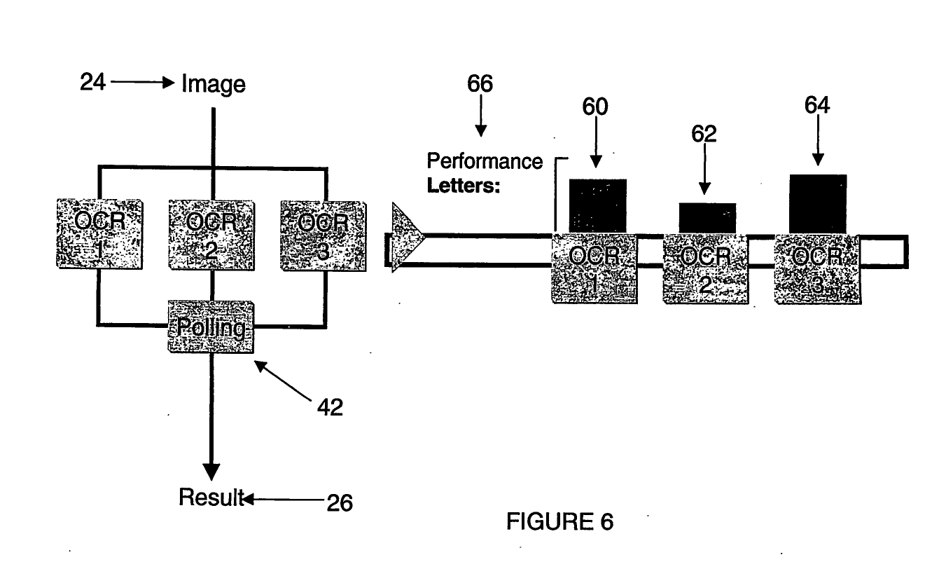

FIG. 6 depicts the above described process applied to the reading and coding of mail items, the mail items comprising, in this example, letters 66. The OCR processes each have a ranking 60, 62, 64 for performance of the letters.

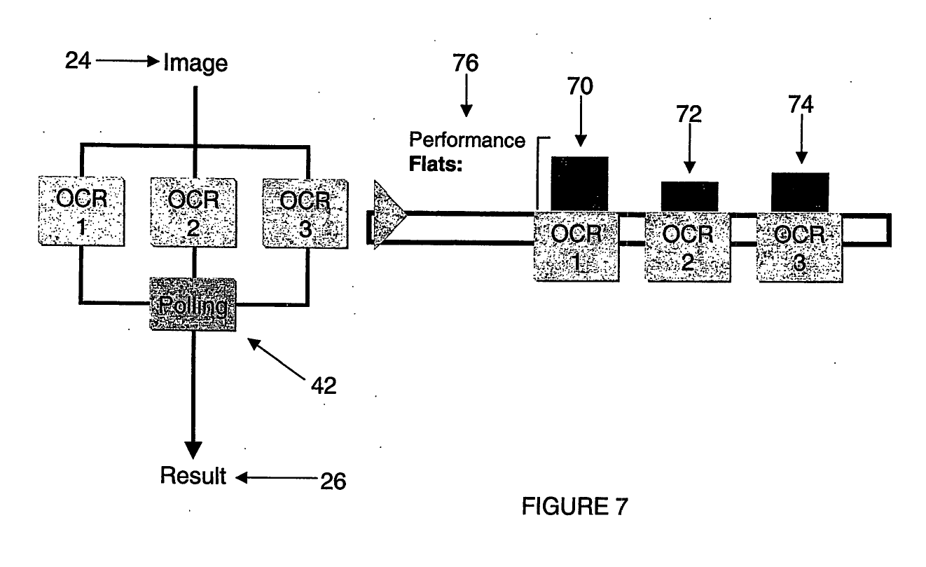

FIG. 7, depicts the different OCR process rankings 70, 72, 74 as applied to reading and coding of flats 76. As may be appreciated, this arrangement applies to all considerations common to the OCR processes.

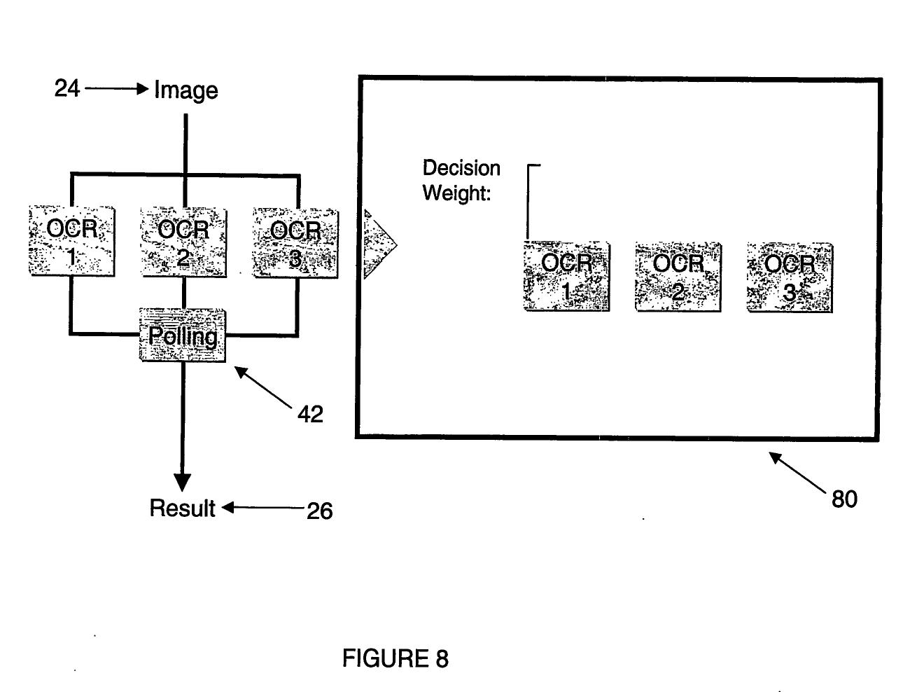

FIG. 8 depicts the decision process 80 which is automatically performed by the polling element 42. Other means, appropriately configured to effect the decision process may be used with or in place of the polling. The amount of required data supporting a weight and application requirements for appropriate reading and coding vary.

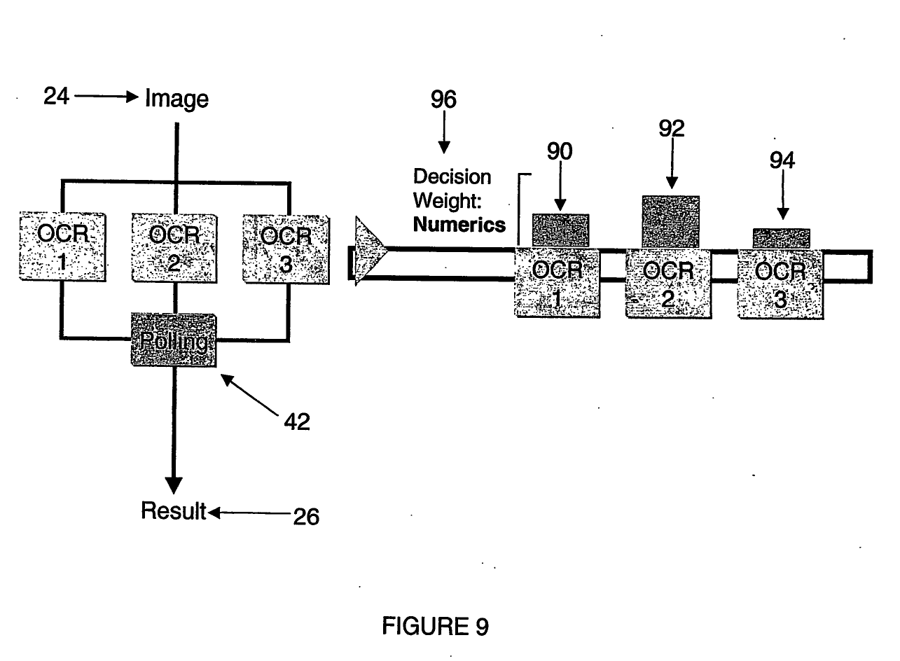

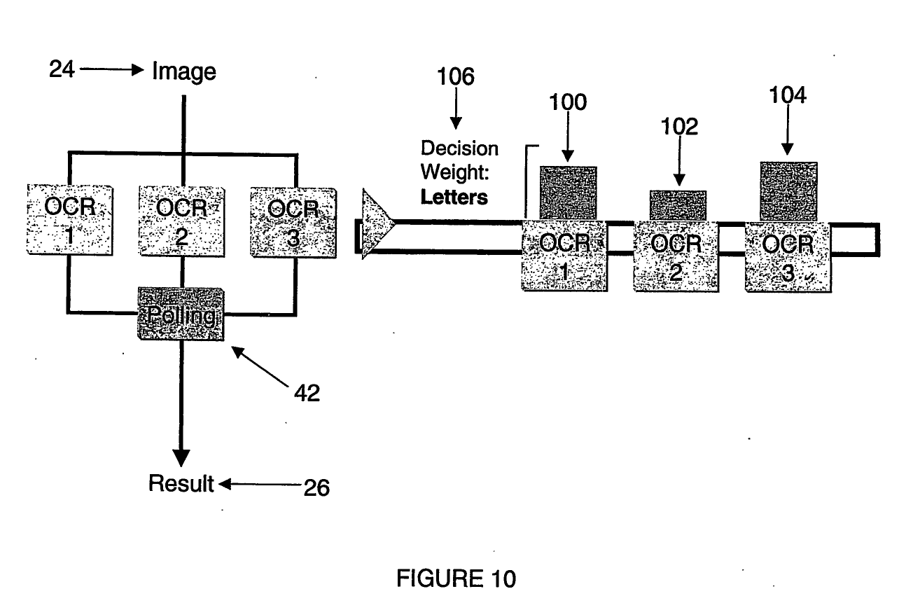

FIG. 9, depicts weighted decisions with respect to numerics 96. As with the above, the weighted decision is depicted in bar graph form. The bar graphs of FIG. 9 (90, 92, 94) correspond in value to the bar graphs of FIG. 5 (50, 52, 54) which also dealt with numerics. The same relationship may be found between FIG. 10 (100, 102 and 104) and FIG. 6 (60, 62, 64) the both of which deal with letters.

Known statistical techniques, such as Null Hypotheses Testing may be used to map the encoder evaluations to a decision regarding an OCR's weight such that only statistically significant relative differences are reflected in the final polling decision process.

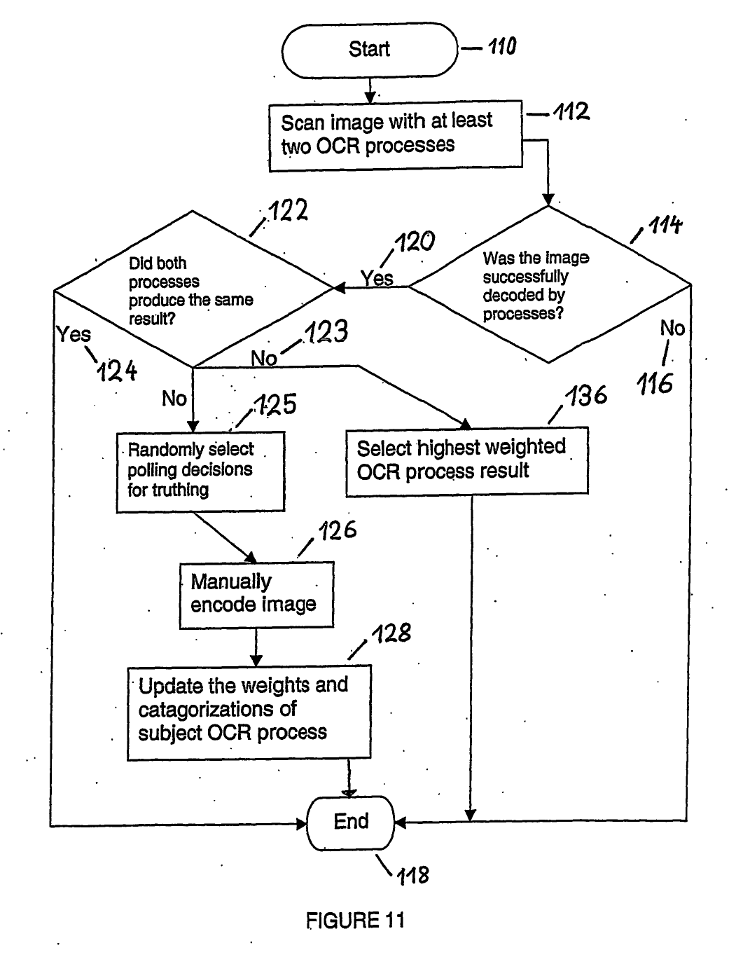

FIG. 11 depicts a flowchart of a method according to the step of scanning the image with at least two OCR processes 112. The present invention may be used with any number of OCR processes. A determination 114 is made whether all OCR processes successfully decoded the image. If the OCR processes did not successfully decode the image 116, then the method ends 118 and the image would most likely proceed to video coding.

If the OCR processes successfully read the image 120, another determination 122 is made, namely whether the OCR processes produced a substantially same result. If the OCR processes produced substantially the same result with sufficient reliability as required by the current application 124, the need for polling is obviated and the method ends 118.

If the OCR processes did not produce the substantially same result 123, the method continues with polling. Herein, a highest weighted OCR process categorization based performance is accepted as a correct decoding 136 and the process ends 118.

A second polling related step includes manual truthing of randomly selected polling decisions so as to further improve the precision of the statistical inference 125. Accordingly, an operator video codes an image 126 and indicates a correctness of the polling decision and the statistics for the related OCR process further incremented or if the polling was in error, the related OCR process weights are decremented 128. The method then ends 118.

1. A method of decoding images comprising the steps of:
applying in parallel at least a first and a second optical character recognition process to an image, said image including a plurality of categorizations,
determining if said first and second optical character recognition processes produce a substantially similar image result,
if said image result is not similar, select a highest weighted OCR process categorization based result, and
assigning said highest weighted OCR process categorization based result to said image result on a categorization by categorization basis.

2. The method according to claim 1, wherein at least one of said categorizations is directed to identification of an envelope upon which said image is printed.

3. The method according to claim 3, wherein said at least one categorization is directed to whether said image is handwritten or machine printed.

4. The method according to claim 3, wherein said at least one categorization is directed to whether said image is handwritten or machine printed.

5. The method according to claim 3, wherein said at least one categorization is directed to identifying a background of color of said envelope.

6. The method according to claim 3, wherein said at least one categorization is directed to whether said envelope is a window or non-window envelope.

7. The method according to claim 3, wherein said at least one categorization is directed to whether said image is an address with or without a post code.

8. The method according to claim 3, wherein said at least one categorization is directed to whether said image is skewed.

9. The method according to claim 3, wherein said at least one categorization is directed to whether said envelope is glossy.

10. The method according to claim 3, wherein said at least one categorization is directed to whether said image is printed on a flat mail piece or a regular mail piece.

11. The method according to claim 3, wherein said at least one categorization is directed to numerics.

12. The method according to claim 3, wherein said at least one categorization is directed to letters.

13. The method according to claim 3, wherein said at least one categorization is directed to flats.

14. The method according to claim 3, wherein said at least one categorization is directed to an inward sorting process.

15. The method according to claim 3, wherein said at least one categorization is directed to an outward sorting process.

16. (canceled)

17. (canceled)

18. A method of decoding images comprising the steps of:
applying in parallel at least a first and a second optical character recognition process to an image, said image including a plurality of categorizations,
determining if said first and second optical character recognition processes produce a substantially similar image result,
if said image result is not similar, manually encode the image, and
statistically updating a weight of an OCR process based upon image encoding.

19. (canceled)
